(19) United States
(12) Patent Application Publication
(10) Pub. No.: US 2021/0397983 A1
(43) Pub. Date: Dec. 23, 2021

(54) PREDICTING AN OUTCOME OF A USER JOURNEY

(71) Applicant: Capital One Services, LLC, McLean, VA (US)

(72) Inventors: Rohit Sarin, Dallas, TX (US); Weiyan Sun, Carrollton, TX (US); Alex Baird, Carrollton, TX (US); Ryan Tomlinson, Frisco, TX (US)

(73) Assignee: Capital One Services, LLC, McLean, VA (US)

(21) Appl. No.: 16/903,823

(22) Filed: Jun. 17, 2020

(51) Int. Cl. G06N 5/04; G06N 20/00; G06Q 40/02; G06Q 10/10

(52) U.S. Cl. CPC G06N 5/04; G06Q 10/105; G06Q 40/025; G06N 20/00

(57) ABSTRACT

The present disclosure is directed to systems and methods for predicting an outcome of a user journey. For example, a method may include: monitoring interactions of a user with a plurality of touchpoints; predicting, based on a machine learning model, whether the interactions will result in a first outcome or a second outcome different than the first outcome, the machine learning being trained using a dataset based on historical interaction data, the dataset comprising a first plurality of patterns resulting in the first outcome and a second plurality of patterns resulting in the second outcome, wherein the predicting is based on a minimum number of interactions with the plurality of touchpoints; and providing an alternative interaction with the plurality of touchpoints to increase a probability that the interactions will result in the second outcome.

### BACKGROUND

Touchpoints are a building block of user experiences with a company or brand. For example, touchpoints may be any interaction between a customer and a product, brand, business, or service. In some instances, touchpoints may be direct interactions with the product, brand, business, or service, or they may be an indirect interaction (e.g., an online review.) It is important for user experience (UX) designers to better understand users' interactions with these touchpoints to enhance each user experience.

### BRIEF DESCRIPTION OF THE DRAWINGS

The accompanying drawings are incorporated herein and form a part of the specification.

FIG. 1 is a block diagram of a system, according to some embodiments.

FIG. 2 is a flowchart illustrating a process for predicting an outcome of a user journey, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for predicting an outcome of a user journey.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

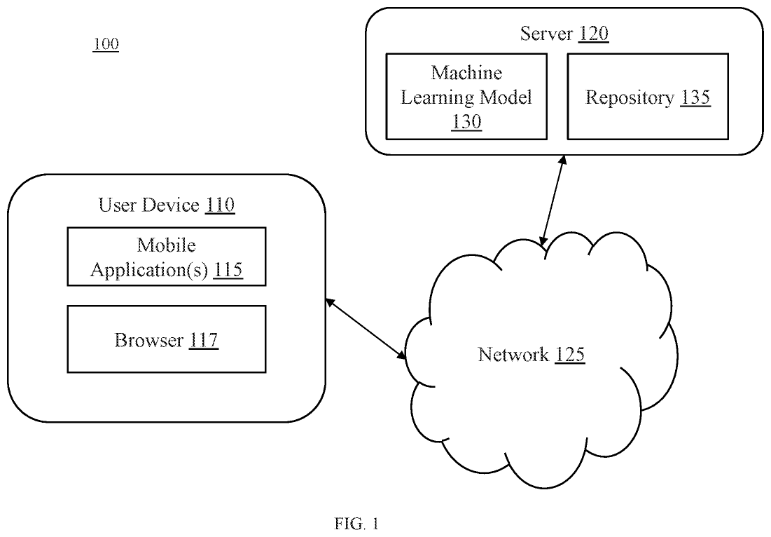

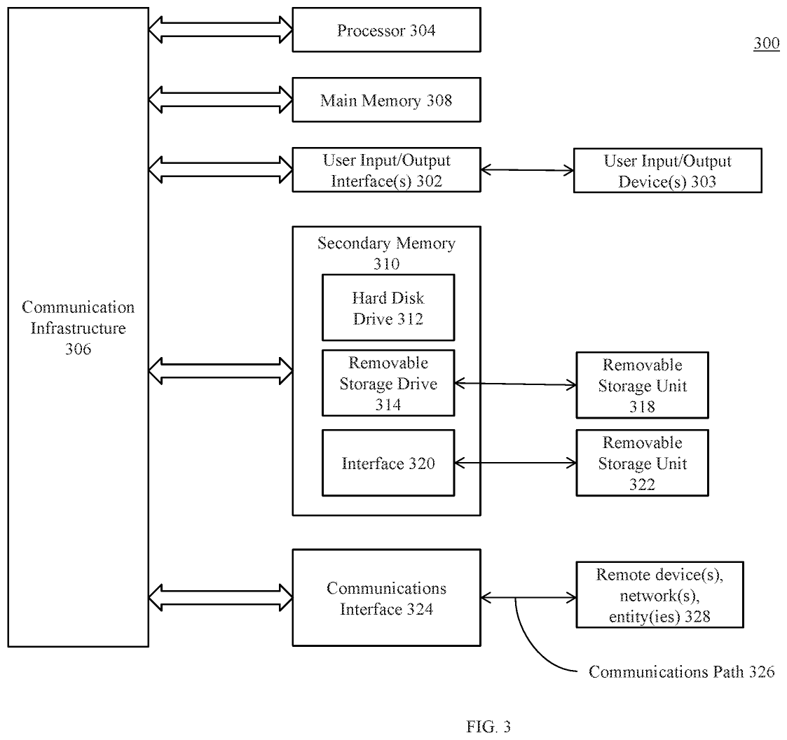

FIG. 1 is a diagram of an example environment 100 in which systems and/or methods, described herein, may be implemented. As shown in FIG. 1, environment 100 may include a client device 110, a server 120, a network 125. Devices of the environment 100 may interconnect via wired connections, wireless connections, or a combination of wired and wireless connections. Devices of environment 100 may include a computer system 300 shown in FIG. 3, discussed in greater detail below.

In some embodiments, the client device 110 may be any device that may be used to access an account associated with an operator of the server 120. For example, the client 110 may be a device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. The client device 110 may include one or more mobile applications 115 and/or a browser 117. For example, the one or more mobile applications 115 may include a mobile application associated with an operator of the server 120. In some embodiments, a user may interact with a plurality of touchpoints via the mobile application 115. In further embodiments, the user may interact with the plurality of touchpoints via a website using the browser 117.

The plurality of touchpoints may include advertisements (e.g., a pass-through or a click-through advertisement), a blog associated with associated with a company, a product review page, a website or marketplace, an interactive support channel, such as a chat window, a live telephone call, a video call, or electronic mail (email) support), a search bar, a pop-up window (e.g., an informational pop-up, an exit-intent pop-up, etc.), a call to action button, an invoice, a purchase acknowledgement, a customer feedback survey, or the like.

The server 120 may include a server device (e.g., a host server, a web server, an application server, etc.), a data center device, or a similar device, capable of communicating with the client device 110 via the network 125. The server 120 may include a machine learning model 130 trained to predict whether interactions of the user with the plurality of touchpoints will result in a first outcome or a second outcome. The server 120 may also include a repository 135 for storing historical interaction data related to prior interactions of a plurality of users with the plurality of touchpoints.

The historical interaction data may include information related to a plurality of user journeys of multiple users through the plurality of touchpoints. For example, the user journeys may be an end-to-end user experience with the plurality of touchpoints. Each user journey may indicate each touchpoint that the user interacted with and whether or not the user opted to purchase a product, apply for a loan or credit card, open a new bank account, subscribe for a new service, or took any sort of action.

The server 120 may be configured to categorize each user journey of the plurality of user journeys into different patterns. For example, the server 120 may categorize each user journey of the plurality of user journeys based on whether or not the user opted to purchase a product, apply for a loan or credit card, open a new bank account, subscribe for a new service, or the like. That is, any series of interactions resulting in the user purchasing a product, applying for a loan or credit card, opening a new bank account, subscribing for a new service, or the like (i.e., a first outcome), may be categorized in a first plurality of patterns and any series of interactions resulting in the user not purchasing a product, applying for a loan or credit card, opening a new bank account, subscribing for a new service, or the like (i.e., a second outcome), may be categorized in a second plurality of patterns. For example, when a user interacts with touchpoints A, B, and C, and applies for the loan or credit card, this user journey may be categorized in the first plurality of patterns. In contrast, when a user interacts with touchpoints A, B, and D, and does not apply for the loan or credit card, this user journey may be categorized in the second plurality of patterns.

To achieve this, the server 120 may process the historical interaction data using a modelling pipeline. In some embodiments, the modelling pipeline may be based on a combination of one or more techniques, such as a pattern mining technique, a recursive feature elimination technique, a gradient boosting technique, and/or the like. The pattern mining technique may be, for example, a sequential pattern mining technique (e.g. a sequential pattern discovery using equivalence classes (SPADE) technique, a frequent closed sequential pattern mining technique, a vertical mining of maximal sequential patterns (VMSP) technique, and/or the like). In further embodiments, the modeling pipeline may be based on one or more data mining techniques, such as tracking patterns, classification, association, or clustering.

In some embodiments, the server 120 may use a classification technique, such as a logistic regression classification technique, a random forest classification technique, a gradient boosting machine (GBM) classifier technique, and/or the like to determine that a particular user journey is associated with a particular touchpoint set and the resultant outcome. Using the above examples, the server 120 may determine that a first user journey may include the combination of touchpoints A, B, and C resulting in the first outcome (e.g., the user applying for the loan or credit card) and that a second user journey may include the combination of touchpoints A, B, and D resulting in the second outcome (e.g., the user not applying for the loan or credit card). As such, the server 120 may process the historical interaction data to determine the plurality of patterns, including the first plurality of patterns resulting in the first outcome and the second plurality of patterns resulting in the second outcome. In this way, the server 120 may organize thousands, millions, or billions of user journeys.

Using the patterns identified in the historical interaction data, the server 120 may train a machine learning model 130. For example, the machine learning model 130 may be trained using a dataset based on the historical interaction data. In some embodiments, the machine learning model 130 may be trained using a supervised learning algorithm. The supervised machine learning algorithm may include, for example, any classification algorithm, such as, but not limited to, regression algorithms (linear and logistic), Naive Bayes classifiers, nearest neighbor, support vector machines (SVM), decision trees, boosted trees, random forest, and/or neural networks. The machine learning model may be used to analyze current user interaction data to predict whether the current user interaction will result in the first outcome or the second outcome.

The network 125 may include one or more wired and/or wireless networks. For example, the network 125 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

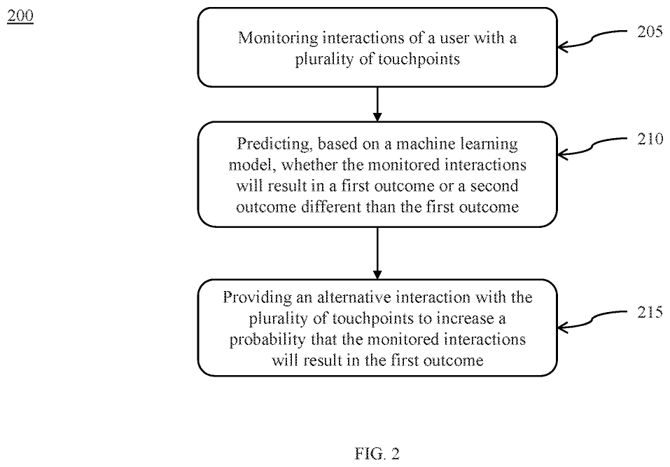

FIG. 2 is a flow chart of an example method 200 for predicting an outcome of a user journey. In some embodiments, one or more processes described with respect to FIG. 2 may be performed by a server device (e.g., the server 120 of FIG. 1). At 205, the method 200 may include monitoring interactions of a user with a plurality of touchpoints. The plurality of touchpoints may be any point where the user interacts with a company, as discussed above. In some embodiments, the user may interact with the plurality of touchpoints using the client device 110. For example, the plurality of touchpoints may be provided to the client device 110 over the network 125 using, for example, the mobile application 115 or the browser 117. The interactions of the user with the plurality of touchpoints may include current user interaction information, i.e., real-time information indicating which touchpoints of the plurality of touchpoints the user is interacting with (e.g., as the current user interaction takes place).

At 210, the method may further include predicting, based on the machine learning model, whether the monitored interactions will result in the first outcome or the second outcome different than the first outcome. For example, the first outcome may be when the user opts to purchase a product, apply for a loan or credit card, open a new bank account, subscribe for a new service, or the like. In contrast, the second outcome may be when the user opts not to purchase a product, apply for a loan or credit card, open a new bank account, subscribe for a new service, or the like. In some embodiments, the predicting may be based on determining whether the monitored interactions match one of the first plurality of patterns or the second plurality of patterns. In some embodiments, the prediction may be based on a minimum number of interactions with the plurality of touchpoints, e.g., 15 interactions, such that the server 120 may match the monitored interactions with one of the first plurality of patterns or one of the second plurality of patterns. That is, by using the minimum number of interactions, the server 120 may have a sufficient number of interactions to match the monitored interactions with one of the first plurality of patterns or one of the second plurality of patterns.

In some embodiments, predicting whether the monitored interactions will result in the first outcome or the second outcome may be based on an attribute of the user. For example, the attribute may include a credit score, an income, a current employment status, a length of current employment, employment history, a residence status, or a length of current residency. It should be understood by those of ordinary skill in the art that these are merely example attributes and that other attributes are further contemplated in accordance with aspects of the present disclosure. When the current interaction is for a product, loan/credit card, bank account, service, or the like having a threshold requirement, the server 120 may determine whether the attribute of the user satisfies the threshold requirement and predict whether the current interaction will result in the first or second outcome accordingly. For example, the server 120 may predict that the current interaction may result in the second outcome based on the attribute failing to satisfy the threshold requirement or result in the first outcome based on the satisfying the threshold requirement.

Furthermore, predicting whether the monitored interactions will result in the first outcome or the second outcome may include generating a probability score indicating whether the current interaction will result in the first outcome. For example, the probability score may be based on each interaction with the plurality of touchpoints and whether the current interactions resemble a pattern from among the first plurality of patterns or a pattern from among one of the second plurality of patterns. As such, the probability score may be adjusted as the user interacts with more and more touchpoints. The probability score may be calculated using, for example, a non-binary logistic regression algorithm, e.g., a multinomial (polytomous) logistic regression. The probability score may be based on a scale from 0 to 1. It should be understood by those of ordinary skill in the arts that this is merely an example for calculating the probability score and that other algorithms for calculating the probability score are further contemplated in accordance with aspects of the present disclosure. The server 120 may use each interaction with the plurality of touchpoints as an input variable of the non-binary logistic regression algorithm and the probability score may be an output calculated based on these inputs, as should be understood by those of ordinary skill in the art. Thus, as the user interacts with more and more touchpoints, an accuracy of the probability score increases.

In 215, the method 200 may also include providing an alternative interaction with the plurality of touchpoints to increase a probability that the monitored interactions will result in the first outcome. For example, when the server 120 predicts that the monitored interactions will result in the second outcome, the server 120 may be configured to determine that action needs to be taken to facilitate changing the predicted outcome from the second outcome to the first outcome, i.e., determine the alternative interaction. The alternative interaction may be, for example, an alternate path to a product, credit card/loan, bank account, service, or the like, that redirects the user to a pattern resulting in the first outcome. The alternative interaction may also include providing the user with online support (e.g., a link to frequently asked questions (FAQs) or an interactive support channel, such as a chat window, a live telephone call, or a video call). In some embodiments, the server 120 may be configured to provide the alternative interaction while the user is currently interacting with the plurality of touchpoints. In this way, the server 120 may enhance a user experience and circumvent the user interactions from resulting in the second outcome. By providing the user with the alternative interaction, the probability score may increase. Namely, as the user is redirected to a pattern resulting in the first outcome, the probability score may indicate that the monitored interactions will result in the first outcome has increased.

In some embodiments, the server 120 may be further configured to determine an interaction for which the attribute of the user satisfies the threshold criteria. For example, the server 120 may identify a credit card/loan having a threshold requirement (e.g., a minimum credit score) for which the attribute of the user satisfies (e.g., the user's credit score satisfies the minimum credit score of the alternate credit card/loan). The server 120 may then provide this interaction as the alternative interaction. By providing the user an alternative interaction that the user is qualified for, the non-binary logistic regression algorithm may further indicate that the probability score is increased.

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system embodiments other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
monitoring interactions of a user with a plurality of touchpoints;
predicting, based on a machine learning model, whether the interactions will result in a first outcome or a second outcome different than the first outcome, the machine learning being trained using a dataset based on historical interaction data, the dataset comprising a first plurality of patterns resulting in the first outcome and a second plurality of patterns resulting in the second outcome, wherein the predicting is based on a minimum number of interactions with the plurality of touchpoints; and
providing an alternative interaction with the plurality of touchpoints to increase a probability that the interactions will result in the second outcome.

2. The method of claim 1, wherein the predicting is further based on an attribute of the user.

3. The method of claim 2, wherein the predicting comprises:
determining whether the attribute of the user satisfies a threshold requirement; and
predicting whether the current interaction will result in the first or second outcome based on whether the one or more attribute satisfies the threshold requirement, wherein the current interaction results in the first outcome based on the attribute failing to satisfy the threshold requirement and the current interaction results in the second outcome when the attribute of the user satisfies the threshold requirement.

4. The method claim 3, wherein, when the current interaction results in the first outcome based on the attribute failing to satisfy the threshold requirement, the method further comprises determining an interaction for which the attribute satisfies the threshold criteria, and wherein the providing the alternative interaction comprises providing the determined interaction as the alternative interaction.

5. The method of claim 2, wherein the attribute comprises a credit score, an income, a current employment status, a length of current employment, employment history, a residence status, or a length of current residency.

6. The method of claim 1, wherein the minimum number of touchpoints comprises between fifteen and fifty touchpoints.

7. The method of claim 1, wherein the predicting comprises generating a probability score indicating whether the current interaction will result in the second outcome, and wherein the providing the alternative interaction increases the probability score.

8. A system, comprising:
a memory for storing instructions for predicting an outcome of a user journey; and
a processor, communicatively coupled to the memory, configured to execute the instructions, the instructions causing the processor to:
monitor interactions of a user with a plurality of touchpoints;
predict, based on a machine learning model, whether the interactions will result in a first outcome or a second outcome different than the first outcome, the machine learning being trained using a dataset based on historical interaction data, the dataset comprising a first plurality of patterns resulting in the first outcome and a second plurality of patterns resulting in the second outcome, wherein the predicting is based on a minimum number of interactions with the plurality of touchpoints; and
provide an alternative interaction with the plurality of touchpoints to increase a probability that the interactions will result in the second outcome.

9. The device of claim 8, wherein the predicting is further based on attribute of the user.

10. The device of claim 9, wherein, to predict whether the current interaction will result in the first outcome or the second outcome, the processor is further configured to:
determine whether the attribute of the user satisfies a threshold requirement;
predict whether the current interaction will result in the first or second outcome based on whether the one or more attribute satisfies the threshold requirement, wherein the current interaction results in the first outcome based on the attribute failing to satisfy the threshold requirement and the current interaction results in the second outcome when the attribute of the user satisfies the threshold requirement.

11. The device of claim 10, wherein when the current interaction results in the first outcome based on the attribute failing to satisfy the threshold requirement, the processor is further configured to determine an interaction for which the attribute satisfies the threshold criteria, and wherein, to provide the alternative interaction, the processor is further configured to provide the determined interaction as the alternative interaction.

12. The device of claim 9, wherein the attribute comprises a credit score, an income, a current employment status, a length of current employment, employment history, a residence status, or a length of current residency.

13. The device of claim 8, wherein the minimum number of touchpoints comprises between fifteen and fifty touchpoints.

14. The device of claim 9, to predict whether the current interaction will result in the first outcome or the second outcome, the processor is further configured to generate a probability score indicating whether the current interaction will result in the second outcome, and wherein the providing the alternative interaction increases the probability score.

15. A non-transitory, tangible computer-readable device having instructions stored thereon that, when executed by at least one computing device, causes the at least one computing device to perform operations comprising:
monitoring interactions of a user with a plurality of touchpoints;
predicting, based on a machine learning model, whether the interactions will result in a first outcome or a second outcome different than the first outcome, the machine learning being trained using a dataset based on historical interaction data, the dataset comprising a first plurality of patterns resulting in the first outcome and a second plurality of patterns resulting in the second outcome, wherein the predicting is based on a minimum number of interactions with the plurality of touchpoints; and
providing an alternative interaction with the plurality of touchpoints to increase a probability that the interactions will result in the second outcome.

16. The device of claim 15, wherein the predicting is further based on attribute of the user.

17. The device of claim 16, wherein the predicting comprises:
determining whether the attribute of the user satisfies a threshold requirement; and
predicting whether the current interaction will result in the first or second outcome based on whether the one or more attribute satisfies the threshold requirement, wherein the current interaction results in the first outcome based on the attribute failing to satisfy the threshold requirement and the current interaction results in the second outcome when the attribute of the user satisfies the threshold requirement.

18. The device of claim 17, wherein, when the current interaction results in the first outcome based on the attribute failing to satisfy the threshold requirement, the operations further comprise determining an interaction for which the attribute satisfies the threshold criteria, and wherein the providing the alternative interaction comprises providing the determined interaction as the alternative interaction.

19. The device of claim 15, wherein the predicting comprises generating a probability score indicating whether the current interaction will result in the second outcome, and wherein the providing the alternative interaction increases the probability score.

20. The device of claim 15, wherein the predicting comprises generating a probability score indicating whether the current interaction will result in the second outcome, and wherein the providing the alternative interaction increases the probability score.
